(19) United States
(12) Patent Application Publication
(10) Pub. No.: US 2024/0154707 A1
(43) Pub. Date: May 9, 2024

(54) METHODS AND APPARATUS FOR ESTIMATING RECEIVED SIGNAL STRENGTH VARIATIONS

(71) Applicant: Telefonaktiebolaget LM Ericsson (publ), Stockholm (SE)

(72) Inventors: Jose OUTES CARNERO, Torremolinos (ES); Adriano MENDO MATEO, Malaga (ES); Yak NG MOLINA, Malaga (ES); Juan RAMIRO MORENO, Malaga (ES); Paulo Antonio MOREIRA MIJARES, Malaga (ES); Jose Maria RUIZ AVILES, Malaga (ES)

(21) Appl. No.: 18/280,015

(22) PCT Filed: Apr. 15, 2021
(86) PCT No.: PCT/EP2021/059792

§ 371 Date: Sep. 1, 2023

(30) Foreign Application Priority Data
Mar. 5, 2021 (EP) 21382189.5

(51) Int. Cl. H04B 17/318; H04B 17/391; H04L 5/00; H04W 56/00

(52) U.S. Cl. CPC H04B 17/328; H04B 17/3913; H04L 5/0051; H04W 56/0045

(57) ABSTRACT

A method of estimating, for an antenna of a base station, variations in received signal strength at User Equipments, UEs, the method comprising: transmitting, to a plurality of UEs, a reference signal; receiving, as input data: signal strength measurements indicating received reference signal strength of the reference signal from the UEs, and positional information from the UEs; generating model coefficients by processing the input data in a training model; and estimating variations in received signal strength of the received reference signal received at the UEs, the estimated variations corresponding to an electrical tilt change of the antenna, wherein the variations in received signal strength are estimated by: processing, in a prediction model, the generated model coefficients, a Remote Electrical Tilt, RET, increment which defines the electrical tilt change, and the positional information received from the UEs.

### TECHNICAL FIELD

Embodiments of the present disclosure relate to methods and apparatus of estimating, for an antenna of a base station, variations of received signal strength at User Equipments, UEs, and in particular methods and apparatus for optimising an electrical tilt configuration of a group of antennas associated with a network of cells using the estimated signal strength variations.

### BACKGROUND

Radio Frequency (RF) design in a wireless cellular telecommunication network considers the overall Quality of Service (QoS) perceived by subscribers to the network. Generally, optimal RF design involves a complex trade-off between capacity, coverage and quality. Considering overall QoS is important for Long-Term Evolution (LTE) networks, specifically for interference control, because techniques such as frequency planning, as would be used with 2G (Global System for Mobile Communications (GSM)), and soft-handover, as would be used with 3G (Universal Mobile Telecommunications System (UMTS)), are not available. For LTE, one-to-one reuse is the most common type of frequency deployment used for maximising spectrum efficiency.

RF design is performed by simultaneously determining antenna configurations for every cell selected to be part of the network. Antenna configuration comprises: antenna type, antenna height, antenna azimuth, mechanical tilt of the antenna and electrical tilt of the antenna.

With the appearance of tools for automatic RF design and tuning, costs have decreased drastically, along with the lead time, while the number of cells that can be optimised simultaneously has increased. Moreover, the use of automatic approaches may reduce the risk of implementing a poor plan, which could be generated when relying on “expert intuition”.

In general, automatic RF tuning focuses on electrical tilt changes, especially if Remote Electrical Tilt (RET) technology is available. RET allows bulk changes via script files through a computer console at negligible cost. Other parameters (e.g. mechanical tilt, height or azimuth), on the other hand, require a site visit for a manual change. Additionally, the other parameters that require a manual adjustment are sensitive to errors in database storage. In this sense, an engineer assistant might need to visit a site to execute a request to modify a cell azimuth from e.g. 20 to 40 degrees and finally find out that the actual azimuth was 50 degrees.

The usage of OSS (Operational Support System) statistics in combination with automation approaches ensures that the customer experience is taken into account for each and every suggested RF change. Hence, the use of OSS with automation approaches maximises the probability of success by using an efficient and comprehensive process based on tools.

Typical optimisation approaches have evolved and converged in terms of the type of input source data they use (e.g. Performance Management (PM) and/or Cell Traffic Recording (CTR) data available at the OSS). Additional inputs may be required for typical optimisation approaches; some of these additional inputs are, in most cases, difficult to obtain.

In general, there are two types of previous optimisation approaches for automatic RF optimisation: cell-based optimisation and area-based optimisation, both of which are discussed in more detail below.

In cell-based optimisation, independent RF optimisation is performed for every cell to decide the optimal antenna tilt value for that cell without considering other cells within the same network. The optimisation is normally based on expert rules using metrics obtained from the same cell, but metrics from surrounding cells may also be used in some cases. Cell-based optimisation is typically adopted for Self-Organising Network (SON) solutions and can be useful to automatically detect and fix a suboptimal operation of a particular cell, which can be fixed automatically with no need of human intervention. This optimisation approach is normally executed using algorithms executed in an iterative way by using refreshed metrics after the changes recommended in the previous iteration have been applied. The iterative algorithms can correct the effect of external factors to the network performance, such as environment variations, and also the effect of the gradual growth and expansion of the network, as well as other internal configuration updates. An example of an iterative algorithm is discussed in V. Buenestado, M. Toril, S. Luna-Ramirez, J. M. Ruiz-Aviles and A. Mendo, “Self-tuning of Remote Electrical Tilts Based on Call Traces for Coverage and Capacity Optimization in LTE,” IEEE Transactions on Vehicular Technology, vol. 66, no. 5, pp. 4315-4326, May 2017.

With the rise of Artificial Intelligence (Al) and Machine Learning (ML), alternative solutions for RET optimisation based on reinforcement learning (RL) have been proposed, and in some cases with the target of facilitating the coordination of decisions made for different but related cells.

Existing cell-based optimisation approaches depend on the availability and reliability of input parameters, such as antenna electrical tilt, antenna mechanical tilt, antenna azimuth and antenna location. Existing cell-based optimisation approaches may suffer from one or more of the following issues:
Most existing cell-based optimisation approaches do not consider current antenna tilt values (i.e. current mechanical tilt and current electrical tilt). Existing cell-based optimisation approaches may also assume that an antenna tilt increase will always reduce a respective cell's coverage area and interference to neighbouring cells, whereas in reality some users of the respective cell will experience increased received signal power while others users will experience a decrease in received signal power. The proportion of users in each of these situations depends on the current antenna tilt value.
Existing cell-based optimisation approaches may require the current antenna tilt values to be known as an input value. However, the current antenna tilt values are not always available or they are not totally reliable. Antenna mechanical tilt values are particularly unreliable.
The iterative algorithms used with existing cell-based optimisation approaches require multiple steps to converge (i.e. to approach the optimal solution). Each of these steps require one or more days of data collection in which periodical measurements need to be acquired.

In area-based optimisation, metaheuristic search algorithms search for a combination of electrical tilts that maximise a cost function which represents the performance of an entire network, rather than focusing on a cell Key Performance Indicators (KPI).

For a moderate size network, the number of combinations to evaluate is enormous. For this reason, metaheuristic search algorithms are typically used. Area-based optimisation permits flexibility of how individual cells are optimised. For example, cells with higher traffic may be prioritised for improved performance. Other strategic or commercial criteria may also be considered. Area-based optimisation is normally executed in one-shot mode (i.e. only one iteration of the algorithm is required in order to provide the final optimised antenna tilt values). However, area-based optimisation requires parameters that are very difficult to characterise and/or include larger errors (e.g. antenna patterns, propagation model, user location and cable losses). An example of area-based optimisation is discussed in J. Ramiro and K. Hamied, “Self-organizing networks: self-planning, self-optimization and self-healing for GSM, UMTS and LTE,” John Wiley & Sons, 2011.

Existing area-based optimisation approaches may suffer from one or more of the following issues:
Area-based optimisation approaches may require parameters that are very difficult to characterise and/or parameters that include larger errors. Examples of such parameters include:
   Antenna patterns: databases with information on antenna pattern diagrams per each cell are costly to create and maintain and are not always available from operators. Moreover, even with perfectly updated information, antenna pattern diagrams provided by manufacturers are based on measurements carried out in ideal environments (e.g. anechoic chambers), and significant deviations are expected as compared to real environments where surrounding elements impact the real antenna patterns arbitrarily (e.g. buildings, trees, mountains and man-made structures in the vicinity of the antenna).
   Propagation characterisation: Most efforts to circumvent the problem of characterising the radio propagation environments concentrate on these three techniques to obtain geolocated radio propagation measurements:
      Propagation model tuning based on drive tests: this is the longest-used approach based on real measurements acquired by measuring received signal levels at various positions around a cell. Drive tests are costly and time consuming. Moreover, it is very seldom that they include measurements acquired from indoor locations.
      Use of geolocated virtual drive tests generated from information contained in CTR data: this approach is less costly but requires previous activation of periodical measurements. Current accuracy of geolocation based on CTR data is limited and post processing manipulation is usually needed to make the data usable for antenna tilt optimisation. Although accuracy can be increased by activating Minimisation of Drive Test (MDT), the percentage of users supporting this feature is still very small.
      Use of crowdsourcing data: this type of data is widely available for all operators in most countries with no need for previous activation of periodical measurements. It provides geolocated measurements with high accuracy, but the spatial density of samples is still poor in most cases.
   Parameters required to compute Reference Signal Received Power (RSRP), such as: antenna azimuth, antenna location, antenna mechanical tilt, antenna electrical tilt, cable losses and other attenuations.

### SUMMARY

It is an object of the present disclosure to provide methods of RET optimisation which require fewer input parameters and that do not require knowledge about a propagation environment.

Aspects of embodiments provide a base station, a network node, a system comprising a base station and a network node, methods and computer programs which at least partially address one or more of the challenges discussed above.

An aspect of the disclosure provides a method of estimating, for an antenna of a base station, variations in received signal strength at User Equipments, UEs. The method comprises transmitting, to a plurality of UEs, a reference signal. The method further comprises receiving, as input data signal strength measurements indicating received reference signal strength of the reference signal from the UEs and positional information from the UEs. The method further comprises generating model coefficients by processing the input data in a training model. The method further comprises estimating variations in received signal strength of the received reference signal received at the UEs. The estimated variations correspond to an electrical tilt change of the antenna. The variation in received signal strength are estimated by processing, in a prediction model, the generated model coefficients, a Remote Electrical Tilt, RET, increment which defines the electrical tilt change, and the positional information received from the UEs.

Optionally, the method may further comprise configuring the electrical tilt of the antenna based on the estimated variation or variations in received signal strength.

Optionally, the electrical tilt of the antenna may be configured by estimating a variation in received signal strength of the received reference signal corresponding to a plurality of different RET increments, determining a signal strength value corresponding to each estimated variation in received signal strength, comparing the determined signal strength values against each other to determine a maximum signal strength value, and selecting the RET increment corresponding the maximum signal strength value as the RET increment to be used for configuring the antenna.

Another aspect of the disclosure provides a base station configured to estimate, for an antenna of the base station, variations in received signal strength at User Equipments, UEs. The base station comprises processing circuitry and a memory containing instructions executable by the processing circuitry. The base station is operable to transmit, to a plurality of UEs, a reference signal. The base station is further operable to receive, as input data signal strength measurements indicating received reference signal strength of the reference signal from UEs and positional information from the UEs. The base station is further operable to generate model coefficients by processing the input data in a training model. The base station is further operable to estimate variations in received signal strength of the received reference signal at the UEs. The estimated variations correspond to an electrical tilt change of the antenna. The variations in received signal strength are estimated by a prediction model configured to process the generated model coefficients, a Remote Electrical Tilt, RET, increment which defines the electrical tilt change, and the positional information received from the UEs.

Another aspect of the disclosure provides a base station configured to estimate, for an antenna of the base station, variations in received signal strength at User Equipments, UEs. The base station configured to transmit, to a plurality of UEs, a reference signal. The base station is further configured to receive, as input data signal strength measurements indicating received reference signal strength of the reference signal from UEs and positional information from the UEs. The base station is further configured to generate model coefficients by processing the input data in a training model. The base station is further configured to estimate variations in received signal strength of the received reference signal at the UEs. The estimated variations correspond to an electrical tilt change of the antenna. The variations in received signal strength are estimated by a prediction model configured to process the generated model coefficients, a Remote Electrical Tilt, RET, increment which defines the electrical tilt change, and the positional information received from the UEs.

Another aspect of the disclosure provides a network node configured to estimate, for an antenna of a base station, variations in received signal strength at User Equipments, UEs. The network node comprise processing circuitry and a memory containing instructions executable by the processing circuitry. Thereby, the network node is operable to receive, from the base station, as input data signal strength measurements indicating received reference signal strength of the reference signal at UEs, and positional information of the UEs. The network node is operable to generate model coefficients by processing the input data in a training model. The network node is operable to estimate variations in received signal strength of the received reference signal at the UEs. The estimated variations correspond to an electrical tilt change of the antenna. The variations in received signal strength are estimated by a prediction model configured to process the generated model coefficients, a Remote Electrical Tilt, RET, increment which defines the electrical tilt change, and the positional information received from the UEs.

Another aspect of the disclosure provides a system comprising a base station and a network node. The system is configured to estimate, for an antenna of the base station, variations in received signal strength at User Equipments, UEs. The system further comprises processing circuitry and a memory containing instructions executable by the processing circuitry. Thereby the system is operable to transmit from the base station to a plurality of UEs, a reference signal. The system is operable to receive at the base station, as input data signal strength measurements indicating received reference signal strength of the reference signal from UEs, and positional information from the UEs. The system is operable to transmit, from the base station to the network node, the input data and to generate, at the network node, model coefficients by processing the input data in a training model. The system is operable to estimate, at the network node, variations in received signal strength of the received reference signal at the UEs. The estimated variations correspond to an electrical tilt change of the antenna. The variations in received signal strength are estimated by a prediction model configured to process the generated model coefficients, a Remote Electrical Tilt, RET, increment which defines the electrical tilt change, and the positional information received from the UEs.

Another aspect of the disclosure provides a system comprising a base station and a network node. The system is configured to estimate, for an antenna of the base station, variations in received signal strength at User Equipments, UEs. The system is configured to transmit from the base station to a plurality of UEs, a reference signal. The system is further configured to receive at the base station, as input data signal strength measurements indicating received reference signal strength of the reference signal from UEs and positional information from the UEs. The system is further configured to transmit, from the base station to the network node, the input data. The system is further configured to generate, at the network node, model coefficients by processing the input data in a training model. The system is further configured to estimate, at the network node, variations in received signal strength of the received reference signal at the UEs. The estimated variations correspond to an electrical tilt change of the antenna. The variations in received signal strength are estimated by a prediction model configured to process the generated model coefficients, a Remote Electrical Tilt, RET, increment which defines the electrical tilt change, and the positional information received from the UEs.

Another aspect of the disclosure provides a computer-readable medium comprising instructions which, when executed on a computer, cause the computer to perform the method of estimating, for an antenna of a base station, received signal strength variations at a UE.

Further aspects provide apparatuses and computer-readable media comprising instructions for performing the methods set out above, which may provide equivalent benefits to those set out above.

Advantageously, the base station, the network node, the system comprising a base station and a network node, the methods and the computer programs of the present disclosure may be used to improve existing RET optimisation algorithms as well as to estimate the tilt of an antenna.

### BRIEF DESCRIPTION OF DRAWINGS

For a better understanding of the present disclosure, and to show how it may be put into effect, reference will now be made, by way of example only, to the accompanying drawings, in which:

FIG. 1 is a flowchart illustrating an estimation method for an antenna of a base station;

FIG. 2A is a schematic diagram of a base station or a system, respectively configured to perform the estimation method of FIG. 1;

FIG. 2B is another schematic diagram of the base station or the system, respectively;

FIG. 3A is a schematic diagram of an OSS for configuring electrical tilt of a plurality of antennas;

FIG. 3B is another schematic diagram of the OSS;

FIGS. 4A and 4B are flow diagrams for estimating a variation in received signal strength of a received reference signal corresponding to an RET increment;

FIG. 5 is a graphical representation of normalised vertical antenna pattern gain;

FIG. 6 is a graphical representation of real signal strength measurements provided by UEs as a function of a distance between respective UEs and an antenna (in grey) and estimated received signal strength measurements derived by the estimation method (in solid black);

FIG. 7 is a graphical representation of the normalised vertical antenna pattern gain of the training model illustrated in FIG. 6; and

FIG. 8 is a graphical representation of a vertical antenna pattern gain at a previous RET value and a vertical antenna pattern gain at an RET increment.

### DETAILED DESCRIPTION

The following sets forth specific details, such as particular embodiments for purposes of explanation and not limitation. It will be appreciated by one skilled in the art that other embodiments may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Embodiments of the present disclosure provide Al-based methods (e.g. regression analysis) to predict the impact of RET changes (i.e. RET increments) on signal strength measurements (i.e. RSRP measurements) collected via CTR data, with minimal required input parameters (i.e. input data) and no need for knowledge on the propagation environment.

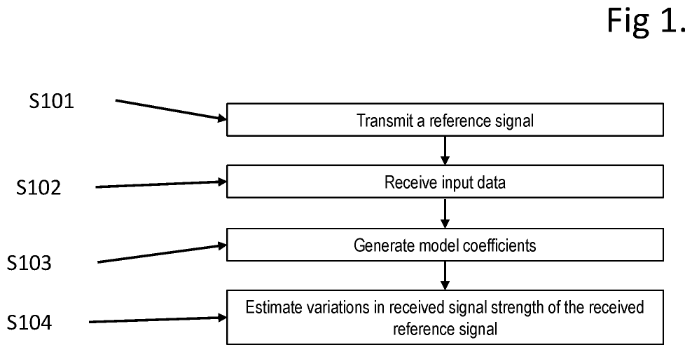

FIG. 1 is a flowchart illustrating an estimation method for an antenna of a base station. In particular, the estimation method may estimate the impact that an electrical tilt change would have on respective received reference signal strength at UEs e.g.

obtained by signal strength measurements (i.e. measurements indicating the received reference signal strength) performed by UEs located in a cell of the base station. Based on the knowledge of an estimated variation in signal strength measurements associated with an electrical tilt change of an antenna, and current signal strength measurements, a power offset may be calculated. The power offset may be applied to all measurements received from UEs in the cell based on the knowledge of distance between respective UEs and the antenna, and antenna height above ground elevation level. By applying the power offset in this way, RET optimisation of the antenna can be performed for the cell.

The power offset depends on the relative vertical angle between respective UE locations and the antenna, the RET increment, and gain of the antenna at the relative vertical angles. Therefore, characterisation of the current vertical antenna pattern gain is estimated using periodical measurements reported by the UEs without requiring full antenna pattern characterisations. This vertical antenna pattern gain characterisation can be performed independently for different base station cells with no need for knowing other antenna parameters, such as electrical and mechanical tilt.

The antenna described above in relation to the flowchart of FIG. 1 may alternatively be referred to as a base station antenna, and the term “base station antenna” will be used to describe the antenna mentioned in FIG. 1 hereafter.

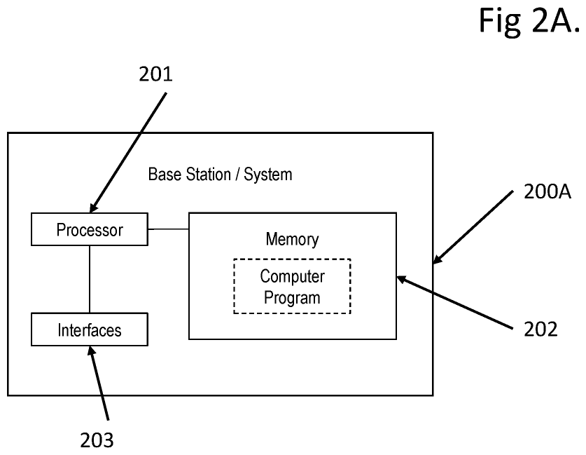

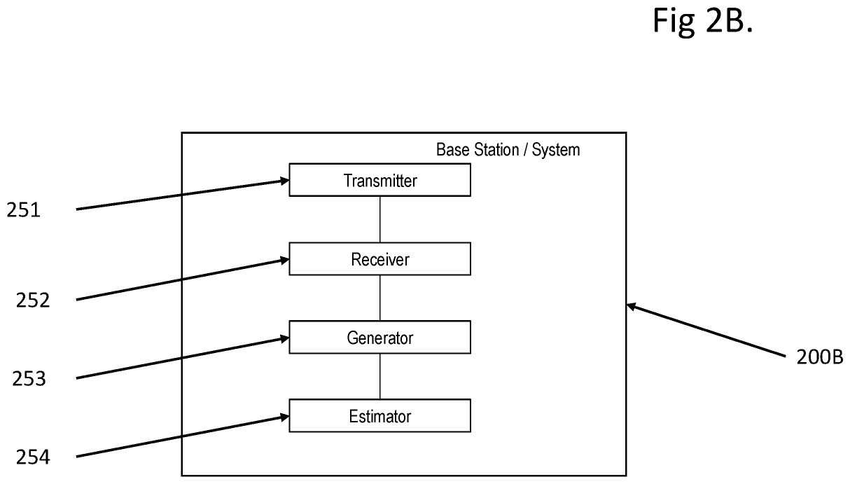

FIGS. 2A and 2B show base stations or systems, respectively 200A and 200B in accordance with certain embodiments. The base stations 200A and 200B may perform the method of FIG. 1. The method of FIG. 1 may alternatively be performed by the system 200A, 200B comprising a base station and a network node, as illustrated in FIGS. 2A and 2B. In embodiments where the method of FIG. 1 is performed by the system 200A, 200B, steps S101 and S102, as discussed below, may be performed by the base station of the system. The base station of the system may then transmit input data to the network node and steps S103 and S103, as discussed below, may be performed by the network node of the system. The base station may transmit the reference signal to a plurality of UEs using a first transmitter and transmit the input data to the network node using a second transmitter. In certain embodiments, the first and second transmitter may be the same transmitter.

The base station or system, respectively, 200A, 200B comprises an antenna configured to communicate with a plurality of UEs.

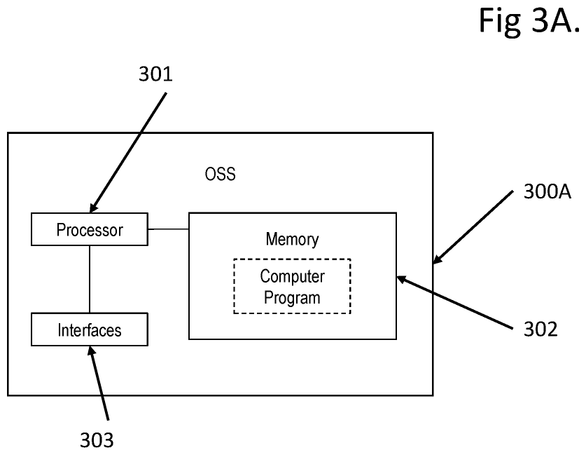

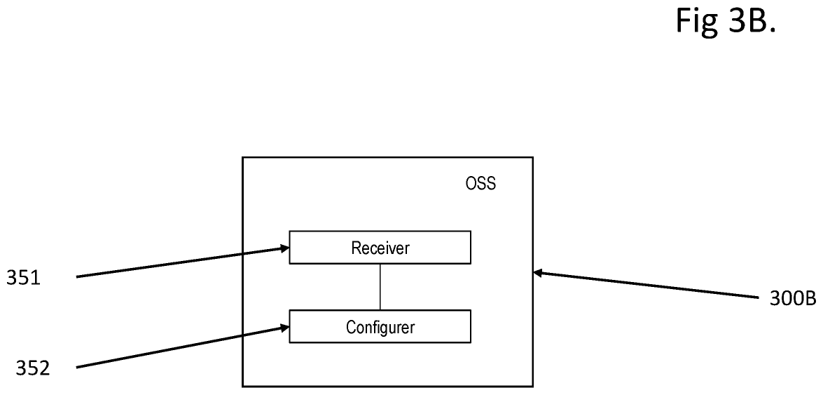

Further, FIGS. 3A and 3B show an OSS 300A, 300B in accordance with certain embodiments. The OSS may communicate with plural base stations or systems, respectively, 200A, 200B in order than electrical tilt of each base station antenna can be configured at a system level while considering the impact of each electrical tilt configuration on signal strength measurements in adjacent base station cells. In certain embodiments the OSS may be alternatively referred to as a network node. Steps S102, S103 and S104 as discussed below can be performed by the OSS 300A, 300B. In this regard step S102 is performed in such a way that input data is received from a base station instead from the UEs. Filtering as described below can be applied at the base station or at the OSS 300A, 300B.

In order that a communication connection can be established between the base station or system, respectively 200A, 200B and the plurality of UEs located within the cell of the base station or system, respectively, 200A, 200B, a reference signal is transmitted from the base station antenna to the plurality of UEs, at step S101. The reference signal may be any signal that can be used to establish the communication connection, for example a Cell Specific Reference Signal (CRS). The reference signal may be generated and transmitted, for example, by a processor 201 of the base station or system, respectively 200A running a program stored on a memory 202 in conjunction with interfaces 203, or may be performed by a transmitter 251 of the base station or system, respectively, 200B.

In step S102, input data is received at the base station antenna. Input data comprises any data that may be used in a training model for the purpose of generating model coefficients to be used in estimating a variation in received signal strength of the received reference signal (i.e. the power offset, mentioned above). Input data may comprise at least one of the following:
signal strength measurements indicating received reference signal strength of the received reference signal performed by the UEs and transmitted from the UEs to the base station antenna. Signal strength measurements may be received from UEs served by the base station antenna and/or UEs not served by the base station antenna (i.e. UEs that are served by another antenna and not served by the base station antenna);
UE positional information transmitted from UEs served by the base station antenna to the base station antenna;
a base station antenna height above ground elevation level;
an effective tilt of the base station antenna which is calculated as the sum of electrical tilt and mechanical tilt. Electrical tilt is a change to an angle of vertical antenna pattern gain caused by varying a phasing between antenna elements. Mechanical tilt is a change to the angle of vertical antenna pattern gain caused by physically moving the antenna. The effective tilt may be calculated by the base station based on empirical data (e.g. acquired from visiting the antenna site) or analytical data (e.g. acquired from antenna data tables stored by the base station);
single signal strength measurements of co-located UEs. Co-located UEs are identified as UEs that are located within a predefined distance of a same fixed position. For example, a first UE and a second UE may be identified as co-located if their respective positional information indicates that they are both located within one meter of a geographical location, such as an address or specific co-ordinates. In this case, the respective signal strength measurements received from the co-located UEs are combined into a single signal strength measurement and the single signal strength measurement is converted into input data. The single signal strength measurement may be calculated as the average, median, or a certain percentile of the respective signal strength measurements;
positional information of UEs served by a second antenna and not served by the base station antenna, were the second antenna and the base station antenna are co-located. That is, in a case where the base station antenna is located at the same position as the second antenna (i.e. co-located), positional information received by the second antenna from UEs not served by the base station antenna is transmitted from the second antenna to the base station antenna. The positional information received from the second antenna is converted into input data.

Input data may be received by the base station antenna once for a particular RET optimisation or the input data may be received periodically. For example, UEs may transmit signal strength measurements and/or positional information to the antenna at predetermined time intervals of 100 ms or 500 ms. Receiving the input data may be performed, for example, by the processor 201 of the base station or system, respectively, 200A running a program stored on the memory 202 in conjunction with the interfaces 203, or may be performed by a receiver 252 of the base station or system, respectively, 200B.

In some embodiments, the positional information may be positional information received from UEs served by the base station antenna and/or positional information acquired for a UE not served by the base station antenna. Positional information may be acquired for the UE not served by the base station antenna by calculating a position of the UE not served by the base station antenna and converting the calculated position of the UE not served by the base station antenna into positional information. Conversion from the calculated position into positional information for use as input data may be performed, for example, by converting location coordinates into input variables that can be processed by the processor 201 of the base station or system, respectively, 200A running a program stored on the memory 202 in conjunction with the interfaces 203, or may be performed by the generator 253 of the base station or system, respectively, 200B. According to certain embodiments, positional information may be acquired for a plurality of UEs not served by the base station antenna.

In embodiments where signal strength measurements are periodically received from UEs, the position of the UE not served by the base station antenna may be calculated and converting into input data for each signal strength measurement periodically received from the UE not served by the antenna.

According to some embodiments, the position of the UE not served by the base station antenna may be calculated by processing, in an inverted propagation model, the generated model coefficients and the signal strength measurement received from the UE not served by the antenna. That is, the propagation model, discussed in more detail below in relation to step S103, may be rearranged to formulate the inverted propagation model such that a distance d between the base station antenna and the UE not served by the base station antenna is unknown. The known parameters that are input to the inverted propagation model comprise a signal strength measurement provided by the UE not served by the base station antenna and the model coefficients generated in step S103. The inverse propagation model computes the known input parameters to determine the distance d. The position of the UE not served by the base station is determined based on the distance d.

In certain embodiments, the position of the UE not served by the base station antenna may be calculated by processing, in a geolocation model, geolocation information associated with the UE not served by the antenna, wherein the geolocation information comprises: a first geolocation distance between an adjacent antenna serving the UE not served by the base station antenna and the UE not served by the base station antenna; a second geolocation distance between the base station antenna and the adjacent antenna; and a horizontal orientation between the antenna and the adjacent antenna. The two distances and the horizontal orientation are computed using trigonometric techniques to determine the position of the UE not served by the base station antenna.

The input data may be filtered in order to remove erroneous data and/or disregard outlying data in order to improve the accuracy of the estimation method. Various methods of input data filtering may be applied. For example, the input data may be filtered according to at least one of the following methods:
discarding a predetermined percentage of input data received from UEs located at a distance from the base station antenna of more than or equal to a maximum predetermined distance. For example, if positional information received from a UE indicates that the UE is more than or equal to 2 km from the base station antenna, all input data associated with that UE will be disregarded;
discarding a predetermined percentage of input data received from UEs located at a distance from the base station antenna of less than or equal to a minimum predetermined distance. For example, if positional information received from a UE indicates that the UE is less than or equal to 200 m from the base station antenna, all input data associated with that UE will be disregarded;
disregarding input data received from UEs that report receiving a different reference signal from a separate antenna. For example, if a UE is within range of a first antenna of a first base station and a second antenna of a second base station, and the UE receives a reference signal from both the first and second antennas, all input data associated with that UE will be disregarded;
disregarding input data received from UEs that transmit a signal strength measurement which is different to the estimated signal strength measurement by more than or equal to an error threshold value. For example, if an estimated received signal strength measurement of the received reference signal (acquired by the estimation method of certain embodiments) is different to an actual signal strength measurement transmitted by a UE by more than 10 dB, all input data associated with that UE will be disregarded.

In some embodiments, the positional information received from the UEs served by the base station antenna comprises Timing Advance, TA, information. The TA information may be used to determine distances between respective UEs from which the TA information is received and the base station antenna.

According to certain embodiments, a received signal strength of the received reference signal is a Reference Signal Received Power, RSRP, signal. That is, the signal strength measurement of a reference signal received by a UE from the base station antenna may be defined as a RSRP signal.

Once input data has been received by the base station antenna, the method proceeds to generate model coefficients by processing the input data in a training model, at step S103. In certain embodiments, the training model is trained using a prediction model. The prediction model is configured to model three components of the received signal strength of the received reference signal, as follows:
a first component comprising a first model coefficient, wherein the first component models propagation characteristics of the base station. The propagation characteristics modelled by the first component comprise: Cell Specific Reference Signal (CRS) transmission power, power boost, cable losses/other attenuations, UE antenna gain, propagation path loss intercept and maximum antenna gain;
a second component comprising second and third model coefficient, wherein the second component models normalised gain of the base station antenna at vertical angles between each UE from among the plurality of UEs and the base station antenna. The second component therefore models the (normalised) vertical antenna pattern gain of a reference signal. The vertical antenna pattern gain is a function of the relative vertical angle between the main direction of the base station antenna and the line that connects the antenna with a respective UE. The relative vertical angle can be derived from the base station antenna height h and the distance d between the base station antenna and a respective UE by using trigonometry

$$( e . g . α = a tan ( \frac{h}{d} ) ) ;$$

a third component comprising a fourth model coefficient, wherein the third component models propagation loss characteristics of the cell served by the antenna that only depend on distance. In particular, the third component models model the logarithmic variation of the propagation path loss (in dB) with the distance between respective UEs and the base station antenna.

The training model generates model coefficients using analytical methods or numerical methods, such as gradient descent, in order to find a version of the propagation model having first, second, third and fourth model coefficients that minimise the mean square of residuals of input data. In certain embodiments, multiple different versions of the propagation model are generated using a range of model coefficients as prediction model inputs. That is, according to certain embodiments, there may be five different sets of model coefficients each of which are input to a different prediction model. The different prediction models (modified versions of the prediction model) are compared against each other by the training model. The training model identifies the model coefficients which should be used in the subsequent estimating step as the model coefficients that generate a prediction model which best fits the input data (i.e. model coefficients that minimise the mean square of residuals of input data). Training of the training model may include any number of different prediction models and different sets of model coefficients (e.g. 5 or 50 different models and corresponding sets). Generation of the model coefficients may be performed, for example, by the processor 201 of the base station or system, respectively, 200A running a program stored on the memory 202 in conjunction with the interfaces 203, or may be performed by the generator 253 of the base station or system, respectively, 200B.

In certain embodiments, relative vertical angles may be determined using: the base station antenna height h₁ above ground elevation level, the distance d between the base station antenna and respective UE, and the height h₂ above ground elevation level of the respective UE, as follows:

$$a tan ( \frac{{h}_{1} - {h}_{2}}{d} ) .$$

For example, a height above ground elevation level of each UE from which positional information is received may be determined based on an average terrain height per distance value acquired from terrain elevation information of the cell served by the base station antenna (e.g. use terrain elevation maps, which contain a tabular grid with an elevation value per bin, collect all bins at a given distance value, and compute an average of the collected bins).

After the model coefficients have been generated by the training model, the method proceeds to estimate the variations in received signal strength of the received reference signal at the UEs in step 104. (Particularly each of) The estimated variations correspond to an electrical tilt change of the base station antenna. That is, the estimation is performed to determine how a potential change in electrical tilt (the electrical tilt change) of the base station antenna would affect the respective signal strength of the reference signal measured by UEs that receive the reference signal. The potential change in electrical tilt is an amount of electrical tilt change that may be applied to the base station antenna using RET after the RET optimisation has been performed.

In certain embodiments, the electrical tilt change may be performed using RET. The electrical tilt change may be defined in degrees or radians (e.g. 1°, 3°, 10°, 0.0174 rad, 0.0523 rad or 0.174 rad). The magnitude of an electrical tilt change may be defined by an RET increment.

The potential change in electrical tilt which provides the highest (i.e. most improved) estimated variation in received signal strength of the received reference signal, from among a plurality of potential changes in electrical tilt, may be applied to the base station antenna using RET, as discussed in more detail below.

The RET increment may be set at a predetermined value, for example according to data tables defining different ranges of RET increments. Alternatively, the RET increment may be set randomly.

The variations in received signal strength may be estimated by processing in the prediction model, the model coefficients generated in step S103, the RET increment which defines the (potential) electrical tilt change, and positional information received from the UEs in step S102. The positional information processed in the prediction model may be positional information received from UEs served from the base station antenna and/or positional information acquired for a UE not served by the base station antenna. Positional information is acquired for the UE not served by the base station antenna in accordance with the embodiments discussed above.

According to certain embodiments, positional information may be acquired for a plurality of UEs not served by the base station antenna. Further, in embodiments where signal strength measurements are periodically received from UEs, the position of the UE not served by the antenna may be calculated and converting into positional information for each signal strength measurement periodically received from a UE not served by the antenna.

Optionally, the processing, in the prediction model, further comprises processing the antenna height above ground elevation level. The antenna height above ground elevation level (i.e. h) may be used in combination with the positional information (i.e. d) received from UEs to determine relative vertical angles between the base station antenna and respective UEs, using the formula: atan(h/d)).

The estimated variation in received signal strength of the received reference signal is output at step S104 based on the processing performed in the prediction model. That is, prediction model input data comprises: the model coefficients, the RET increment, positional information and, optimally, antenna height above ground elevation level. Prediction model output data comprises the estimated variation in received signal strength of the received reference signal. The variation in received signal strength may be estimated, for example, by a processor 201 of the base station or system, respectively, 200A running a program stored on a memory 202 in conjunction with interfaces 203, or may be performed by an estimator 253 of the base station or system, respectively, 200B.

According to certain embodiments, the processing, in the prediction model, may be performed using only the RET increment, antenna height above ground elevation level, positional information received from UEs, and the second and third model coefficient of the prediction model. That is, the first and fourth coefficients of the prediction model may be omitted from the prediction model processing in step S104. Advantageously, using fewer items of prediction model input data reduces the processing burden of the base station or system, respectively, 200A, 200B. Further, it is feasible to execute the prediction model processing an extensive number of times during offline RET optimisation.

In some embodiments, the estimated variation in received signal strength is estimated by comparing plural instances of the prediction model against each other in order to determine a magnitude of variation in received signal strength. For example, the prediction model input data (i.e. the model coefficients, the RET increment, positional information and, optionally, antenna height above ground elevation level) may be processed in a first instance of the prediction model and a second instance of the prediction model. In the first instance of the prediction model, the second component models the vertical antenna pattern gain of the reference signal at a first vertical angle, wherein the first vertical angle is the current electrical tilt angle of the base station antenna. In the second instance of the prediction model, the second component models the vertical antenna pattern gain of the reference signal at a second vertical angle, wherein the second vertical angle is a sum of the current electrical tilt angle, as defined by the first vertical angle, and the angle defined by the (potential) electrical tilt change. For example, if the current electrical tilt angle is 10° and the (potential) electrical tilt change is 2°, the second vertical angle would be 12°.

The differences between corresponding first and second instances of the prediction model may then be calculated for each element of positional information. In an example where there are 80 UEs that have each provided one element of positional information to the base station antenna, the method will calculate 80 differences between the first and second instances of the prediction model.

The variation in received signal strength may subsequently be estimated as the sum of the calculated differences between the first and second instances of the prediction model for each element of positional information. In the example discussed above, the 80 differences between the first and second instances of the prediction model are summed together to provide a variation value indicating the variation in received signal strength of the received reference signal. Estimating the variation in received signal strength of the received reference signal may be performed, for example, by the processor 201 of the base station or system, respectively, 200A running a program stored on the memory 202 in conjunction with the interfaces 203, or may be performed by the estimator 254 of the base station or system, respectively, 200B.

Optionally, the estimated variation in received signal strength of the received reference signal may be used to configure the electrical tilt of the base station antenna as part of the RET optimisation. According to certain embodiments, the electrical tilt configuration is performed by the base station or system, respectively, 200A, 200B and/or the OSS 300A, 300B.

The method of configuring electrical tilt as performed by the base station, the OSS and/or the system will now be discussed.

The base station or system, respectively, 200A, 200B may configure the electrical tilt of the base station antenna based on the estimated variation in received signal strength. For example, if the estimated variation in received signal strength is determined to be +0.7 dB, the base station or system, respectively, 200A, 200B may use RET to change the electrical tilt of the base station antenna by the RET increment corresponding the estimated variation in received signal strength (e.g. if an RET increment of +4° resulted in the estimated variation in received signal strength of +0.7 dB, the electrical tilt of the base station antenna is changed by +4°).

In order to determine the optimal electrical tilt of the base station antenna, an estimated variation in received signal strength of a received reference signal may be determined for a plurality of different RET increments, and the RET increment determined to provide the largest positive increase in estimated variation in received signal strength is applied to the base station antenna, using RET. That is, a signal strength value corresponding to each estimated variation in received signal strength may be determined (e.g. +0.7 dB, +0.1 dB, −0.3 dB). The signal strength values may then be compared against each other to determine a maximum signal strength value, and the RET value corresponding to the maximum signal strength value may be selected as the RET increment to be applied to the base station antenna, using RET. Optionally, signal quality values and/or interference from adjacent base stations may be used as well as or instead of signal strength values.

In some embodiments, the base station or system, respectively, 200A, 200B may receive estimated variations in received signal strength from a plurality of adjacent base stations, wherein each estimated variation in received signal strength corresponds to a cell of a corresponding base station. For example, each adjacent base station may be configured to perform the estimation method described above in order to estimate a variation in received signal strength of a received reference signal for a respective cell. Each adjacent base station may then transmit the estimated variation to the base station antenna. Once the estimated variations have been received from the adjacent base station antennas, and the estimated variation in received signal strength has been determined according to step S104, the base station or system, respectively, 200A, 200B may configure the electrical tilt of the base station antenna based on the estimated variations in received signal strength received from the adjacent base stations and the estimated variation determined in step S104.

According to certain embodiments, the base station or system, respectively, 200A, 200B may perform RET optimisation at a system level by configuring the electrical tilt of the base station antenna as well as adjacent base station antennas, where the base station antenna and the adjacent base station antennas may be defined as a plurality of antennas. For example, each adjacent base station may estimate a plurality of variations in received signal strength, each variation in received signal strength corresponding to a different RET increment from among a plurality of different RET increments of a respective antenna. That is, each adjacent antenna has a corresponding plurality of different RET increments and a variation in received signal strength is estimated for each of the different RET increments by the corresponding adjacent base station. The plurality of estimated variations in received signal strength may then by transmitted to the base station or system, respectively, 200A, 200B. A signal strength value corresponding to each estimated variation in received signal strength and corresponding to the estimated variation in received signal strength determined according to step S104, may then be determined by the base station or system, respectively, 200A, 200B. The signal strength values of each antenna may then be compared against each other to determine a maximum signal strength value for each antenna. The maximum signal strength values may be subsequently used to determine a maximum radio network performance indicator. Electrical tilt changes of each antenna corresponding to the maximum radio network performance indicator may then be applied to the plurality of antennas by the base station or system, respectively, 200A, 200B, using RET. Optionally, the maximum radio network performance indicator may be determined based on signal strength values, signal quality values and/or interference from adjacent base stations.

In this way, the base station or system, respectively, 200A, 200B performs RET optimisation on a system level by taking into account adjacent base stations when configuring the electrical tilt of the base station antenna and/or the adjacent base station antennas.

According to certain embodiments, the OSS 300A, 300B may perform RET optimisation at a system level by configuring the electrical tilt of the plurality of antennas instead of or as well as the base station or system, respectively, 200A, 200A. For example, each adjacent base station may estimate a plurality of variations in received signal strength corresponding to a plurality of different RET increments. The plurality of variations in received signal strength may then by transmitted to the OSS 300A, 300B. The variations in received signal strength may be received, for example by a processor 301 of the OSS 300A running a program stored on a memory 302 in conjunction with interfaces 303 or may be received by a receiver 351 of the OSS 300B.

A signal strength value corresponding to each estimated variation in received signal strength and corresponding to the estimated variation in received signal strength determined according to step S104, may then be determined by the OSS 300A, 300B. The signal strength values of each antenna may then be compared against each other to determine a maximum signal strength value for each antenna. The maximum signal strength values may be subsequently used to determine a maximum radio network performance indicator. Electrical tilt variations of each antenna corresponding to the maximum radio network performance indicator may then be configured by the OSS 300A, 300B. The configured electrical tilt changes may be applied to the plurality of antennas by the OSS 300A, 300B, using RET. Optionally, the maximum radio network performance indicator may be determined based on signal strength values, signal quality values and/or interference from adjacent base stations. Configuring the electrical tilt of a plurality of antennas may be performed, for example, by a processor 301 of the OSS 300A running a program stored on a memory 302 in conjunction with interfaces 303, or may be performed by a configurer 351 of the OSS 300B.

In some embodiments, UEs may be classified into separate UE groups such that an estimated variation in received signal strength of the received reference signal may be determined for each separate UE group, individually. Each separate UE group may comprise: UEs that are served by the base station antenna, UEs that also receive a plurality of other reference signals from a plurality of corresponding other antennas that is not the serving base station antenna, and UEs that measure a received signal strength of the same other reference signal received from the same other antenna as being the strongest measured received signal strength from among measured received signal strengths of the plurality of other reference signals. For example, if two UEs are served by the base station antenna, and both UEs also measure reference signals from a plurality of corresponding non-serving base station antennas, the two UEs are classified into the same separate UE group if both UEs measure the same non-serving base station antenna as having the strongest reference signal strength, disregarding the serving base station antenna.

For each separate UE group, a separate set of model coefficients may be generated and a separate variation in received signal strength of the received reference signal may be estimated. For example, the variation in received signal strength may be estimated for each separate UE group by processing, in the prediction model, the separate set of model coefficient generated for the respective separate UE group, the RET increment which defines the electrical tilt change, and positional information received from the UEs in the respective separate UE group.

Certain embodiments may simultaneously characterise two or more co-azimuth antennas sharing the same tilt value (i.e. cells with the same azimuth but transmitting reference signals at different frequencies). In co-azimuth antenna embodiments, the reference signal and a second reference signal may both be transmitted to a plurality of UEs from the co-azimuth antenna, wherein the co-azimuth antenna transmits the second reference signal to a second cell at a different frequency to a frequency at which the reference signal is transmitted to a first cell. The co-azimuth antenna may subsequently receive the following, as input data: signal strength measurements of the reference signal from UEs served in the first cell, positional information from the UEs served in the first cell, signal strength measurements of the second reference signal from UEs served in the second cell, and positional information from the UEs served in the second cell. The co-azimuth antenna may transmit N different reference signals to a plurality of UEs in N different cells and receive input data from the plurality of UEs in the N different cells, where N is a positive integer.

The simultaneous characterisation may be performed by adding at least one extra model coefficient to the propagation model per additional frequency. For example, the propagation model may contain one or more offset model coefficients corresponding to the offset between propagation path loss of the second frequency and the first frequency.

In certain embodiments comprising the co-azimuth antenna, a combined variation in received signal strength of the received reference signal and the second received reference signal may be estimated. The combined variation in received signal strength may correspond to an electrical tilt change of the co-azimuth antenna. The combined variation in received signal strength may be estimated by: processing, in the prediction model, the generated model coefficients, the RET increment which defines the electrical tilt change, positional information received from the UEs served in the first cell and the UEs served in the second cell. Optionally, the electrical tilt of the co-azimuth antenna may be configured based on the estimated combined variation in received signal strength. The steps of configuring electrical tilt of the co-azimuth antenna may be analogous to the steps described above in relation to configuring the base station antenna.

The estimation method has multiple advantages and applications that would be appreciated by a person skilled in the art. For example, the estimation method may be used to improve existing RET optimisation algorithms as well as to estimate the effective tilt of an antenna (i.e. the sum of the mechanical tilt and the electrical tilt). Particular advantages and applications may include:
Using the estimation method in existing one-shot algorithms (e.g. Automatic Cell Planning (ACP)). In the case of ACP, the estimation method can replace current “antenna scaling” algorithms, which re-compute the RSRP measurements for all UEs after an RET increment has been applied. Advantageously, using the estimation method avoids the need to use antenna pattern diagrams from manufacturers and complex propagation models, which are normally inaccurate. The need for clutter and elevation maps is also avoided by using the estimation method.
Using the estimation method in existing iterative algorithms, which need to collect periodical measurements for every iteration. With the estimation method, these iterative algorithms could run in offline mode in initial iterations and converge faster, with no need to apply multiple changes to the network and re-collect CTR data during the initial phase. Offline mode of execution also permits one-shot optimisation.
Using the estimation method to allow for RL based approaches to be trained in offline mode before going online.
Using the estimation method to estimate the effective tilt of a cell antenna by calculating the value of a relative vertical angle a that maximises the term associated with the vertical antenna pattern gain in the propagation model described above.

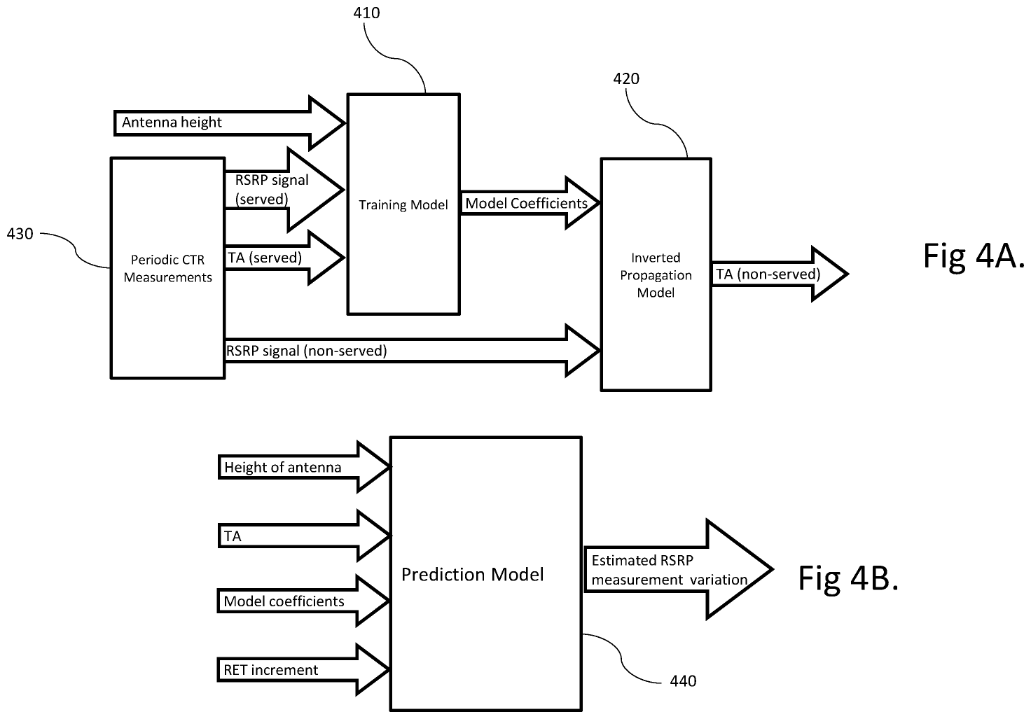

Embodiments of the method for estimating received signal strength at a UE after applying a (potential) electrical tilt change to an antenna serving the UE will now be discussed with reference to FIGS. 4A and 4B. In the following embodiments, “positional information” will be described as “TA information” and “received signal strength of the received reference signal” will be described as an “RSRP”.

The estimation method of FIGS. 4A and 4B uses regression analysis to estimate the coefficients of a quadratic function that models the vertical antenna pattern of the cell antennas, as well as the slope of the logarithmic variation of the propagation path loss with the distance. In order to perform the estimation method of FIGS. 4A and 4B, a linear propagation model for LTE networks is used. Details of the propagation model will now be discussed.

### Propagation Model

As discussed in more detail below, CTR data files acquired from periodic CTR measurements 430 comprise two relevant measurements for the estimation method. These two relevant measurements are: RSRP measurements and TA information.

The RSRP can be defined as the transmission power of the CRS with the addition of gains and the subtraction of losses associated with the different elements that impact propagation from the transmitter (i.e. the antenna) to the receiver (i.e. a UE), in the logarithmic domain. The different elements that impact propagation include:
CRS transmission power: the transmitted CRS power in the linear domain is defined as the maximum transmission power at the cell, divided by the number of Physical Resource Blocks (PRB) and the number of transmit antennas, and multiplied by the power boost (also known as the CRS gain).
Cable losses and other attenuations associated with transferring signals to the antenna.
Cell antenna gain as a function of the relative horizontal and vertical angles between the antenna and respective UEs.
Propagation path loss as a function of the distance between the antenna and respective UEs and is also a function of frequency.
Outdoor-to-indoor penetration losses.
Slow fading, typically caused by events such as shadowing, where a large obstruction such as a hill or large building obscures the main reference signal path between the antenna and respective UEs.
UE antenna gain (typically 2.15 dBi).

For a given cell, the following elements are common for all UEs: CRS transmission power, cable losses and other attenuations and UE antenna gain.

Remaining elements which impact propagation from the antenna to respective UEs are considered in the propagation model by making certain assumption. These assumptions are:
Cell antenna gain variation caused by an RET increment (i.e. a change in electrical tilt implemented by RET) only depends on the relative vertical angle between the cell antenna and respective UEs, and does not depend on azimuth.
Different RET values have identical vertical antenna pattern gains just shifted by an amount that equals the RET increment.
Shadow fading is constant.
Propagation path loss in the logarithmic domain is determined by:
   a common offset (or intercept) that characterises each cell; and
   a logarithmic variation with the distance, having a slope (dB/decade) that characterises each cell.

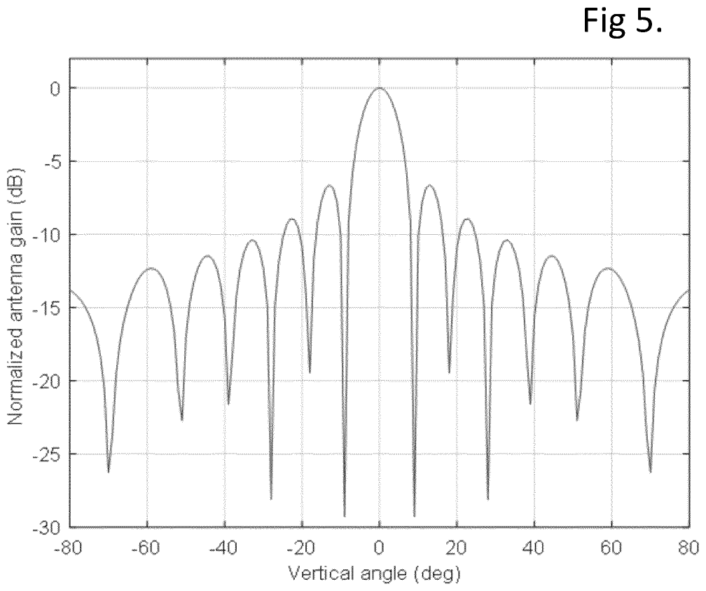

As a result of the above mentioned assumptions, the RSRP can be derived as the sum of three components, in the logarithmic domain, as follows:
A constant value that characterises the cell, which includes: the contribution of the CRS transmission power, cable losses and other attenuations, UE antenna gain, propagation path loss intercept, and maximum cell antenna gain.
A propagation path loss slope that characterises the cell (i.e. a common coefficient), multiplied by the logarithm of the distance between the antenna and respective UEs.
A normalised vertical cell antenna pattern gain that characterises the cell, and depends on the relative vertical angle between the cell antenna and respective UEs. The relative vertical angle is also a function of the distance between the cell antenna and respective UEs. Unlike the propagation path loss, the normalised vertical antenna pattern gain is an increasing function of the distance, up to a certain value associated with maximum vertical antenna gain, and then become a decreasing function of the distance. An example of normalised vertical antenna pattern gain is provided in FIG. 5. FIG. 5 is a graphical representation of normalised vertical antenna pattern gain with normalised antenna gain represented on the y-axis, in dB, and relative vertical angle represented on the x-axis, in degrees. The main radiation lobe is at a vertical angle of 0° and has a gain of OdB. Six side radiation lobes are illustrated on both sides of the main radiation lobe along the x-axis.
An approximation for the normalised vertical cell antenna pattern gain, as illustrated in FIG. 5, is to use a quadratic function of the relative vertical angle. Such a quadratic function includes the main range of possible angles (e.g. from −10 to 10 degrees), where most of the measurements are located, and is therefore a good approximation. In some embodiments, more sophisticated functions could be used in an attempt to model additional radiation lobes.

As discussed in detail below, regression analysis is used to estimate these three components using a training model formulated from the above propagation model. All errors included in the propagation model due to assumptions made are minimised by the regression analysis. Certain adaptions can be made to the propagation model in order to further mitigate the effect of errors in the propagation model due to the above assumptions. These adaptions are discussed in more detail below in the ESTIMATION METHOD: MODIFICATIONS section.

FIG. 4A illustrates phase one and phase two of the estimation method. In phase one, model coefficients are generated using the training model 410 and in phase two TA information corresponding to UEs not served by the antenna (i.e. non-served UEs) is calculated using an inverted propagation model 420. In certain embodiments, phase two may be omitted completely. FIG. 4B illustrates phase three of the estimation method in which an RSRP variation is estimated using the prediction model 440.

The three phases of the estimation method illustrated in FIGS. 4A and 4B may be summarised, as follows:
Phase One: Model training.
Phase Two: Calculate TA information for non-served UEs.
Phase Three: Estimate RSRP measurement variation.

The three phases of the estimation method will now be discussed in detail.

### Phase One: Model Training

In phase one of the estimation method, input data is input to the training model 410 in order to generate the model coefficients. This input data comprises:
An antenna height above ground elevation level.
CTR data (i.e. CTR data files) obtained from the periodic CTR measurements, the CTR data comprising:
   TA measurements from every UE served by the antenna (i.e. served UEs), which provide information about the distance between respective UEs and the serving cell.
   RSRP measurements reported by served UEs.
   RSRP measurements reported by non-served UEs.

The non-served UEs are UEs which are not served by the antenna but receive interference from the antenna in the form of reference signals transmitted from the antenna. RSRP measurements reported by the non-served UEs are used to determine how a particular electrical tilt configuration of the antenna affects UEs in adjacent cells as well as UEs in the cell served by the antenna. For example, RSRP measurements received from non-served UEs in the eight strongest interfered cells may be used as input data.

The TA information is translated into a distance between the antenna and respective UE with a resolution of, for example, 78.125 meters (in accordance with LTE standard “TS 36.213 Physical layer procedures” by the 3rd Generation Partnership Project (3GPP), available at https://porta1.3gpp.org/desktopmodules/Specifications/SpecificationDetails.aspx?specificationId=2427 as of the filing date of this disclosure.)

In particular embodiments, the propagation model discussed above is used to formulate a training model. For a case where a quadratic function is used to characterise the normalised vertical antenna pattern gain, the propagation model is represented by equation (1), below:

$$R SRP = {\underbrace{{w}_{0}}}_{\begin{matrix}( A ) models \\ cell \\ characteristics\end{matrix}} + {\underbrace{{w}_{1} \cdot a tan ( \frac{h}{d} ) + {w}_{2} \cdot {( a tan ( \frac{h}{d} ) )}^{2}}}_{\begin{matrix}( B ) example of quadratic \\ function to model vertical \\ antenna pattern gain\end{matrix}} + {\underbrace{{w}_{3} \cdot log ( d )}}_{\begin{matrix}( C ) models \\ pathloss \\ with distance\end{matrix}} \qquad ( 1 )$$

where RSRP is defined in dBm.

The three elements of the propagation model illustrated in equation 1 (i.e. (A), (B) and (C)) correspond to the three components of the propagation model, as follows:
(A) corresponds to the constant value which characterised the cell, in the propagation model;
(B) corresponds to the normalised vertical cell antenna pattern gain, in the propagation model; and
(C) corresponds to the propagation path loss slope multiplied by the logarithm of the distance between the antenna and respective UEs, in the propagation model.

This propagation model characterises RSRP of a particular UE using four model coefficients, as follows:
The two model coefficients w₁ and w₂ are used to model the quadratic behaviour of the vertical antenna gain (in dB) as a function of the relative vertical angle between the main direction of the antenna and the line that connects the antenna with the UE. The relative vertical angle can be derived from the cell antenna height h and the distance d between the cell antenna and the UE by using trigonometry, as

$$α = a tan ( \frac{h}{d} ) .$$

Notice that concavity of the function that models the normalised vertical antenna gain is only guaranteed if w₂<0. Concavity of the function is required in order to find a local maxima for estimating RSRP measurement variation. The model is linear and therefore can use features built with any linear or non-linear function of the input data.
The model coefficient w₃ is used to model the logarithmic variation of the propagation path loss (in dB) with the distance between respective UEs and the antenna.

The model coefficient w₀ models the common constant component, which is independent of the UE for which RSRP is being estimated. This model coefficient includes the contribution of other parameters, such as: Cell Specific Reference Signal (CRS) transmission power, power boost, cable losses/other attenuations, UE antenna gain, propagation path loss intercept and maximum antenna gain.

The training model is formulated by applying linear regression to the propagation model of equation (1). The training model sets

$$a tan ( \frac{h}{d} ) , {( a tan ( \frac{h}{d} ) )}^{2}$$

and log(d) as input features and the training model is trained using training pairs. Each training pair comprises corresponding TA information and RSRP measurements acquired from the same UE during the periodic CTR measurements 430. For each training pair, the TA information (i.e. distance) is used as training input information and the RSRP measurement is used as training output information. Using either analytical methods or numerical methods (e.g. gradient descend) it is possible to generate model coefficients w₀, w₁, w₂ and w₃ that minimise the mean square of residuals of training pairs in the training model.

Optionally, a filtering step may be included before phase one to filter out input data acquired from the periodic CTR measurements 430 that might introduce high noise into the training model 410 (i.e. remove outliers). Examples of how the input data may be filtered in such a filtering step include:
Removing training pairs of input data having TA information with a small value, because small variations of distance d, which is acquired based on TA information, can produce high variations of relative vertical angle a.
Removing training pairs of input data having TA information with a high value where corresponding RSRP measurements are expected to be in the lowest range of values. These types of training pairs do not always correctly represent the behaviour of the model at the larger distances indicated by the TA information, because most of these types of training pairs have a serving cell that is not the cell under study. Additionally, mechanisms to control the load among different co-located layers might artificially bias the distribution of the RSRP measurements.
Removing training pairs of input data having an RSRP measurement that is very different to other RSRP measurements in the same TA information range. Large discrepancies in RSRP measurements may be caused by not adhering to the assumptions described above in relation to the propagation model.

Advantageously, phase one has to be carried out only once. Therefore, after the training model 410 has been trained, the model coefficients are not modified.

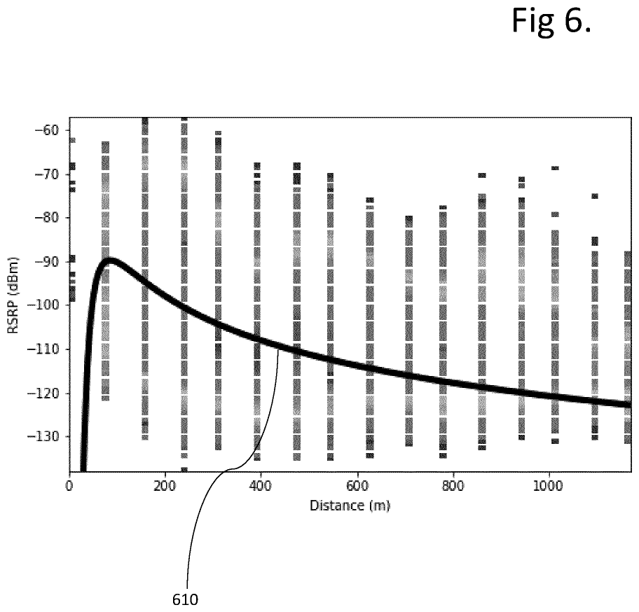

An example of the phase one model training using real data, where a quadratic function is used to model vertical antenna pattern gain, is illustrated in FIG. 6.

FIG. 6 is a graphical representation of real RSRP measurements provided by UEs as a function of a distance between respective UEs and the antenna. The real RSRP values are indicated on the y-axis, in dBm, and distance is indicated on the x-axis, in meters. The vertical grey bars in FIG. 6 illustrate real signal strength measurements provided by UEs as a function of a distance between respective UEs and the antenna. The solid black curved line 610 in FIG. 6 illustrates the training model fit using the following model coefficients:

w₀=−40.7, w₁=1.7, w₂=−0.12, and w₃=−27.2

For the specific cell of the example illustrated in FIG. 6, the training model is represented by equation (2), below:

$$R S R P = - 40.7 + 1.7 \cdot ( a tan ( \frac{h}{d} ) ) - 0.12 \cdot {( a tan ( \frac{h}{d} ) )}^{2} - 27.2 \cdot log ( d ) \qquad ( 2 )$$

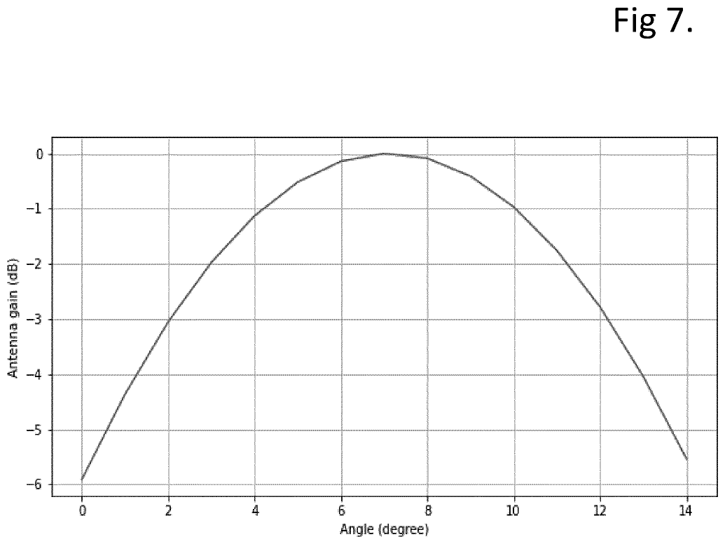

FIG. 7 is a graphical representation of the normalised vertical antenna pattern gain for the training model illustrated in FIG. 6. Antenna gain is indicated on the y-axis, in dB, and angle is indicated on the x-axis, in degrees.

### Phase Two: Calculate TA Information For Non-Served UEs

Once the model coefficients w₀, w₁, w₂ and w₃ have been generated, the estimation method proceeds to phase two, in which TA information (and therefore the distance d from the antenna to respective non-served UEs) is calculated. As discussed above, non-served UEs are UEs that do not have the cell under study as the serving cell, but detect a reference signal transmitted from the antenna of the serving cell and report their respective RSRP measurement to that antenna.

The calculation of TA information from non-served UEs is done by analysing the propagation model in equation (1) inversely in an inverse propagation model 420. That is, known RSRP measurements are used to predict distance d. This inverse analysis requires the non-linear propagation model of equation (1) to be solved for each RSRP measurement received from a non-served UE, where w₀, w₁, w₂, w₃, and the RSRP measurement are known values and distance d in the unknown value. A solution to the inverse analysis may be acquired by using a range of numerical methods, such as a root-finding algorithm (e.g. bisection method and/or regula falsi method). Advantageously, the inverse analysis can be parallelised using plural computer cores, and the inverse analysis only needs to be executed once as part of RET optimisation.

TA information of the non-served UEs is subsequently used in phase three of the estimation method in order that the impact of an RET increment on UEs served by other cells is taken into account as part of the RET optimisation.

### Phase Three: Estimate RSRP Measurement Variation

Phase three estimates a variation in RSRP measured by UEs corresponding to a potential RET increment that could be applied to the antenna. As discussed above in the list of assumptions, the vertical antenna pattern gain at an RET increment is just a shifted version of the current vertical antenna pattern gain at the current RET value. That is, a vertical antenna pattern gain at the relative vertical angle

$$α = a tan ( \frac{h}{d} )$$

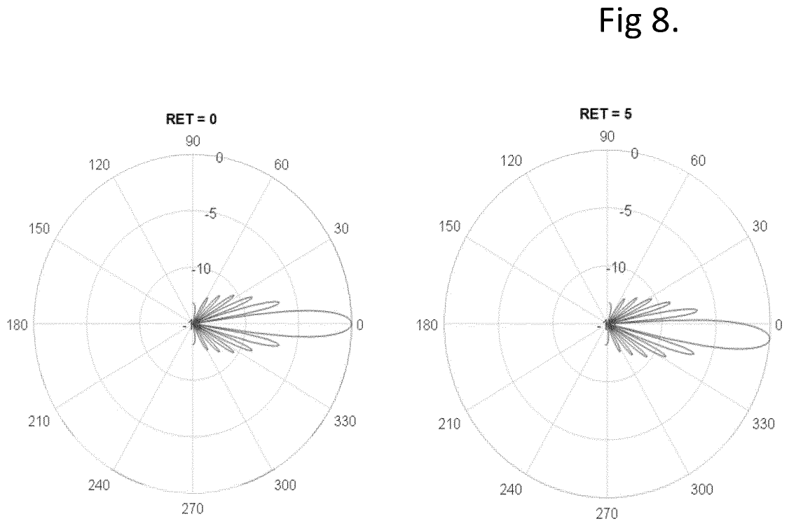

after an RET increment Δt is the same as a current vertical antenna pattern gain at an angle of α−Δt, as illustrated in FIG. 8. Therefore, once the function used to define the normalised vertical antenna pattern gain is known, the variation in received signal strength of the received signal associated with an RET increment can be estimated as: the difference between a vertical pattern antenna gain at the relative vertical angle with an RET increment and a vertical antenna pattern gain at the current relative vertical angle minus the RET increment, as illustrated in equation (4) below.

FIG. 8 is a graphical representation of a vertical antenna pattern gain at a previous RET value and a vertical antenna pattern gain at an RET increment. The graph on the left hand side of FIG. 8 illustrates the vertical antenna pattern gain at an RET value of 0 (i.e. the previous RET value), whereas the graph on the right hand side of FIG. 8 illustrates the vertical antenna pattern gain at an RET value of 5 (i.e. the RET increment). The difference in vertical angle between the two vertical antenna pattern gains is therefore 5°.

In view of the assumption that vertical antenna pattern gain at an RET increment is just a shifted version of the previous vertical antenna pattern gain at the previous RET increment, a prediction model 440 for estimating a variation in RSRP measured by UEs can be formulated using the propagation model discussed above (which is also used to formulate the training model in phase one). For a case where a quadratic function is used to characterise the normalised vertical antenna pattern gain, the prediction model 440 is represented by equation (3), below:

$$RSRP ( d , Δ t ) = {w}_{0} + {w}_{1} \cdot ( {\underbrace{a tan ( \frac{h}{d} )}}_{α} - Δ t ) + {w}_{2} \cdot {( {\underbrace{a tan ( \frac{h}{d} )}}_{α} - Δ t )}^{2} + {w}_{3} \cdot log ( d ) \qquad ( 3 )$$

where RSRP is defined in dBm, the model coefficients w₀, w₁, w₂ and w₃ are obtained from the training model in phase one, h is the height of the antenna above ground elevation level, d is the distance between the antenna and respective UEs,

$$a tan ( \frac{h}{d} )$$

is the previous relative vertical angle and At is the potential RET increment.

With reference to FIG. 4B, the prediction model 440 of equation (3) estimates a variation in RSRP measured by UEs corresponding to a potential RET increment that could be applied to the antenna by processing the following parameters:
Height of the antenna above ground elevation level;
TA information acquired from served UEs via periodic CTR measurements and/or TA information calculated for non-served UEs in phase two;
Model coefficients generated in phase one; and
A potential RET increment

For the case where a quadratic function is used to model the vertical antenna pattern gain, the prediction model 440 of equation (3) can be simplified as follows:

$$RSRP ( d , Δ t ) = [ RSRP of potential RET increment ] - [ RSRP of previous RET value ] = [ {w}_{0} + {w}_{1} \cdot a tan ( \frac{h}{d} ) - {w}_{1} \cdot Δ t + {w}_{2} \cdot ( Δ {t}^{2} - 2 \cdot Δ t \cdot a tan ( \frac{h}{d} ) + a tan {( \frac{h}{d} )}^{2} ) + {w}_{3} \cdot log ( d ) ] - [ {w}_{0} + {w}_{1} \cdot a tan ( \frac{h}{d} ) + {w}_{2} \cdot {( a tan ( \frac{h}{d} ) )}^{2} + {w}_{3} \cdot log ( d ) ] = - {w}_{1} \cdot Δ t - 2 \cdot {w}_{2} \cdot Δ t a tan \cdot ( \frac{h}{d} ) + {w}_{2} \cdot Δ {t}^{2} = - Δ t [ {w}_{1} + {w}_{2} \cdot ( 2 \cdot a tan ( \frac{h}{d} ) - Δ t ) ] \qquad ( 4 )$$

Equation (4) illustrates that the simplified prediction model estimates a variation in RSRP measured by UEs as a function of distance d and RET increment Δt, where the only additional parameters required to calculate the variation in RSRP are h, w₁, and w₂.

Advantageously, the estimation of varied RSRP measurements using the simplified prediction model is computationally light. Therefore, it is feasible to execute this operation an extensive number of times during offline RET optimisation.

### Estimation Method: Modifications

As mentioned above, certain adaptions can be made to the propagation model in order to further mitigate the effect of errors in the propagation model due to various assumptions made. These adaption will now be discussed in the list below with reference to the three phases of the estimation method discussed above. Each adaption may be applied individually or in combination with other adaptions.

List of adaptions:
a) Filter out outlier samples to facilitate the model training in phase 1 based on one or more of the following:
   Discard a predetermined percentage of training pairs having TA information indicating the longest distances to the antenna, for example the top 10% of distances.
   Discard a predetermined percentage of training pairs having TA information indicating the shortest distance to the antenna, for example the bottom 10% of distances.
   Consider only training pairs associated with UEs that are served by the antenna only (i.e. disregard UEs measure reference signal transmitted by one or more additional antennas).
   Once the training model 410 has been trained with all available training pairs, remove outlier training pairs having RSRP measurements that are greater than an RSRP error threshold value, and train the training model 410 again without the removed outliers.
b) Replace the quadratic function that models the normalised vertical antenna pattern gain of the antenna with a more sophisticated function in order to model additional radiation lobes, provided that concavity is guaranteed. For example, such a function may be:

w₁·[sinc(w₂·(α−w₃))]²,

where w₁, w₂ and w₃ are the model coefficients and a is the relative angle between the antenna and the respective UE.
c) Use terrain elevation information acquired from elevation maps to improve the training model 410. For example, UE height could be determined from the terrain elevation information and taken into account when calculating a distance between respective UEs and the antenna as well as when calculating the relative vertical angle.
   One example approach is to use an average terrain height per distance value and per serving cell, regardless of the relative azimuth of the antenna. Elevation map values can be used directly when assuming that non-served UEs are exactly in the azimuth direction of the antenna.
d) Consider UE category information from CTR to adjust RSRP by subtracting UE antenna gain associated with a certain UE category. That is, UE handset model data may be extracted from CTR data in addition to the RSRP. This UE handset model data may then be used to determine antenna gain of the corresponding UE handset. RSRP measurements may be subsequently adjusted based on the UE handset antenna gain (i.e. by subtracting the UE handset antenna gain from the RSRP measurement provided by the corresponding UE).
e) Include samples from non-served UEs which are served by neighbouring intra-frequency co-located antennas when training the training model 410. For co-located antennas, the UEs are at the same distance to all co-located antennas, and therefore the distance to the co-located antennas is known from TA information received from served UEs.
f) Use effective tilt (i.e. the sum of mechanical tilt and electrical tilt of the antenna) to restrict the valid values of the model coefficients during training of the training model 410 and thereby remove outliers during the training.
   The model coefficients are restricted by, for example, iteratively searching for a predefined percentages of training pairs that provide a vertical antenna pattern gain above a certain threshold (e.g. a minimum gain threshold) for that tilt.
g) Consolidate RSRP measurements into a single value per distance and per antenna when training the training model 410.
   The consolidation can be performed using, for example, mean, mode, or a predefined percentile value for each distance.
h) Include training pairs from non-served UEs when training the training model 410 by calculating the distance between respective non-served UEs and the antenna using geolocation methods. That is, since the distance from the non-served UEs is unknown, distance can be calculated based on geolocation methods provided that a position and azimuth of the antenna is known. Two example geolocation methods include:
   Method One: calculating the distance using trigonometry based on the assumption that non-served UEs are exactly in the azimuth direction of the serving cell. This method also requires the distance between respective non-served UEs and their serving antenna to be acquired from the serving antenna.
   Method Two: this method is an extension of method one, where non-served UEs are assumed to be within a range of angles [−a, a] with respect to the azimuth direction of their serving antenna. The angle variation of the non-served UEs with respect to the azimuth direction of their serving antenna is calculated from a composite vector v. This composite vector is the sum of individual vectors, associated with each measured neighbouring antenna. Each individual vector has a magnitude, which is proportional to a corresponding RSRP measurement, and a direction determined by a line that joins a location of the non-served UE (obtained using the distance calculated in method one) with the location of the neighbour. The UE is then calculated to be at a distance from its serving cell with an angle equal to the azimuth of the serving cell plus a·cos[arg(v)]. Once the distances between the non-served UEs and their serving antenna are determined, the distance between the non-served UEs and the antenna can be computed using trigonometry.
i) Once the training model 410 is trained (phase one) and TA information from non-served UEs is calculated (phase two), repeat phase one again after phase two while considering training pairs from served and also non-served UEs (using the estimated distances of the non-served UEs). This adaption can be executed iteratively until convergence. The inverted propagation model 420 will be altered when this adaption is used, and therefore the distances of non-served UEs calculated using the inverted propagation model 420 will be different.
   j) Classify training pairs into different categories within the cell and use a different training model 410 per category per antenna. Each category may be associated with an intra-frequency co-located neighbouring antenna, for example. In this case, a training pair is classified as falling within a first category associated with a co-located neighbouring antenna when an RSRP measurement of a reference signal received from the co-located neighbouring antenna is the strongest from among a plurality of measured reference signals received from a plurality of corresponding non-serving antennas. A second category is used to classify training pairs associated with a neighbouring antenna that is not co-located and an RSRP measurement of a reference signal received from the neighbouring antenna is the strongest from among the plurality of measured reference signals received from the plurality of corresponding non-serving antennas. Alternatively, a unique training model 410 can be formulated for each antenna according to the best fit.
For example, C+1 categories are used, where C is the number of co-located intra-frequency neighbouring cells, and the categories are divided as follows:
   C number of different categories corresponding to the number of different co-located antennas. A training pair is classified as falling within a category corresponding to a particular co-located antenna if an RSRP measurement of a reference signal received from the particular co-located antenna is the strongest from among the plurality of measured reference signals received from the plurality of corresponding non-serving antennas.
   One additional category for all remaining training pairs which are not classified within any of the C previous categories.
k) Extend the model to simultaneously characterise two or more co-azimuth antennas (i.e. antennas with the same azimuth but transmitting at different frequencies). The simultaneous characterisation is performed by adding extra model coefficients per additional frequency, but keeping a unique common model coefficient for all co-azimuth antennas in order to model the logarithmic variation of the path loss with distance.

For example, the propagation model in equation (1) would contain three extra model coefficients per additional co-azimuth antenna: an extra offset coefficient and two extra coefficients to model the vertical antenna pattern gain for every additional frequency. The model coefficient w₃ which models the logarithmic variation of the propagation path loss with distance is unique for all co-azimuth antennas. All samples from all frequencies can be used to train the training model 410. Model coefficients associated with different frequencies are cancelled out for each training pair during training of the training model 410 and/or estimating with the prediction model.
I) Estimate model coefficients by training the training model iteratively until certain technical conditions are met (e.g. initialize w₃ to a fixed predefined value and estimate w₀, w₁ and w₂). The iteration is repeated with different values of w₃ until the model coefficients meet certain requirements, such as:
   the model coefficients are within a range of desired values, and/or
   the model coefficients provide a concave function for the vertical antenna pattern gain with 3 dB beam-width and a maximum value within a predefined range of desired values.

Advantageously, each of these adaptions also reduce noise caused by external factors that are not taken into account in the training model of phase one.

### Estimation Method: Applications

The estimation method described above may be used to improve existing RET optimisation algorithms as well as estimating the effective tilt of an antenna (i.e. the sum of the mechanical tilt and the electrical tilt).

Example application of the estimation method include:
Using the estimation method in existing one-shot algorithms (e.g. Automatic Cell Planning (ACP)). In the case of ACP, the estimation method can replace current “antenna scaling” algorithms, which re-compute the RSRP measurements for all UEs after an RET increment has been applied. Advantageously, using the estimation method avoids the need to use antenna pattern diagrams from manufacturers and complex propagation models, which are normally inaccurate. The need for clutter and elevation maps is also avoided by using the estimation method.
Using the estimation method in existing iterative algorithms, which need to collect periodical measurements for every iteration. With the estimation method, these iterative algorithms could run in offline mode in initial iterations and converge faster, with no need to apply multiple changes to the network and re-collect CTR data during the initial phase. Offline mode of execution also permits one-shot optimisation.
Using the estimation method to allow for RL based approaches to be trained in offline mode before going online.
Using the estimation method to estimate the effective tilt of a cell antenna by calculating the value of a relative vertical angle a that maximises the term associated with the vertical antenna pattern gain in the propagation model of equation (1), as illustrated in equation (5), below:

$${t}_{eff} = {arg max}_{α} \{ {w}_{1} \cdot α + {w}_{2} \cdot {α}^{2} \} = - \frac{{w}_{1}}{2 \cdot {w}_{2}} \qquad ( 5 )$$

It will be understood that the detailed examples outlined above are merely examples. According to embodiments herein, the steps may be presented in a different order to that described herein. Furthermore, additional steps may be incorporated in the method that are not explicitly recited above. For the avoidance of doubt, the scope of protection is defined by the claims.

1. A method of estimating, for an antenna of a base station, variations in received signal strength at User Equipments, UEs, the method comprising:
transmitting, to a plurality of UEs, a reference signal;
receiving, as input data: signal strength measurements indicating received reference signal strength of the reference signal from the UEs, and positional information from the UEs;
generating model coefficients by processing the input data in a training model; and
estimating variations in received signal strength of the received reference signal received at the UEs, the estimated variations corresponding to an electrical tilt change of the antenna, wherein the variations in received signal strength are estimated by: processing, in a prediction model, the generated model coefficients, a Remote Electrical Tilt, RET, increment which defines the electrical tilt change, and the positional information received from the UEs.

2. The method according to claim 1, wherein the method further comprises:
configuring electrical tilt of the antenna based on the estimated variations in received signal strength; and/or
configuring electrical tilt of a plurality of adjacent antennas each corresponding to a different base station based on the estimated variations in received signal strength.

3. The method according to claim 2, wherein
the method further comprises configuring electrical tilt of the antenna based on the estimated variations in received signal strength, and
the electrical tilt of the antenna is configured by:
estimating a variation in received signal strength of the received reference signal corresponding to a plurality of different RET increments,
determining a signal strength value corresponding to each estimated variation in received signal strength,
comparing the determined signal strength values against each other to determine a maximum signal strength value, and
selecting the RET increment corresponding the maximum signal strength value as the RET increment to be used for configuring the antenna.

4. (canceled)

5. The method according to claim 1, wherein
configuring electrical tilt of a plurality of adjacent antennas each corresponding to a different base station based on the estimated variations in received signal strength, and
the electrical tilt of the plurality of antennas is configured by:
receiving, from each of the plurality of adjacent antennas, a plurality of variations in received signal strength of a received reference signal, each variation in received signal strength corresponding to a different RET increment from among a plurality of different RET increments of a respective adjacent antenna,
determining a signal strength value corresponding to each received variation in received signal strength,
comparing the determined signal strength values against each other to determine a maximum signal strength value for each adjacent antenna, and
selecting RET increments corresponding to a maximum radio network performance indicator, defined by the maximum signal strength values, as the RET increments to be used for configuring the adjacent antennas.

6. The method according to claim 1, the method further comprising:
receiving, as input data: signal strength measurements indicating received reference signal strength of the reference signal from UEs served by the antenna, and positional information from the UEs served by the antenna; and
processing, in the prediction model, the generated model coefficients, the RET increment which defines the electrical tilt change, and the positional information received from the UEs served by the antenna.

7. (canceled)

8. The method according to claim 6, wherein the method further comprises:
further receiving, as input data: signal strength measurements from a UE not served by the antenna,
calculating a position of the UE not served by the antenna, and
converting the calculated position of the UE not served by the antenna into positional information,
estimating the variation in received signal strength of the received reference signal corresponding to the electrical tilt change of the antenna, wherein the variation in received signal strength is estimated by: processing, in the prediction model, the generated model coefficients, the RET increment which defines the electrical tilt change, the positional information received from the UEs served by the antenna, and the positional information of the UE not served by the antenna.

9. The method according to claim 1, wherein the method further comprises:
periodically receiving, as input data: signal strength measurements indicating received reference signal strength of the reference signal from UEs served by the antenna, positional information from the UEs served by the antenna, and signal strength measurements from a UE not served by the antenna,
for each signal strength measurement periodically received from the UE not served by the antenna, calculating the position of the UE not served by the antenna, and
converting the calculated positions of the UE not served by the antenna into positional information for use as input data.

10. The method according to claim 8, wherein the position of the UE not served by the antenna is calculated by:
processing, in an inverted propagation model, the generated model coefficients and the signal strength measurement received from the UE not served by the antenna, and/or
processing, in a geolocation model, geolocation information associated with the UE not served by the antenna, wherein the geolocation information comprises:
a first geolocation distance between: an adjacent antenna serving the UE not served by the antenna, and the UE not served by the antenna,
a second geolocation distance between the antenna and the adjacent antenna, and
a horizontal orientation between the antenna and the adjacent antenna.

11. The method according to claim 8, wherein the method further comprises:
periodically receiving, as input data, at the antenna: signal strength measurements from plural UEs not served by the antenna,
calculating the position of the plural UEs not served by the antenna, and
converting the calculated positions of the plural UEs not served by the antenna into positional information for use as input data.

12. The method according to claim 1, wherein the training model generates the model coefficients by:
generating modified versions of the prediction model by inputting a range of model coefficients into the prediction model,
comparing the modified versions of the prediction model to the input data, and
selecting model coefficients from among the range of model coefficients that generate a modified version of the prediction model which best fits the input data.

13. The method according to claim 1, wherein:
the input data further comprises an antenna height above ground elevation level, and/or
the method further comprises:
processing, in the prediction mode, the antenna height above ground elevation level;
calculating an effective tilt of the antenna as the sum of electrical tilt and mechanical title;
converting the calculated effective tilt into input data;
identifying co-located UEs as UEs that transmit positional information indicating a UE position located within a predefined distance of a same fixed position;
processing the signal strength measurements received from the co-located UEs to generate a single signal strength measurement and converting the single signal strength measurement into input data.

14-15. (canceled)

16. The method according to claim 1, wherein the method further comprises:
identifying UEs served by a second antenna co-located with the first antenna and not served by the first antenna,
acquiring, by the first antenna, positional information received by the second antenna from the UEs served by the second antenna and not served by the first antenna, and
converting the position information acquired from the second antenna into input data.

17. The method according to claim 1, wherein the prediction model comprises:
a first component comprising a first model coefficient, wherein the first component models propagation characteristics of the base station,
a second component comprising second and third model coefficient, wherein the second component models gain of the antenna at vertical angles between each UE from among the plurality of UEs and the antenna, and
a third component comprising a fourth model coefficient, wherein the third component models propagation loss characteristics of the cell served by the antenna that only depend on distance.

18. The method according to claim 17, wherein the method further comprises:
calculating a height above ground elevation level of each UE from which positional information is received, wherein the height above ground elevation level of each UE is determined based on an average terrain height per distance value acquired from terrain elevation information of the cell served by the antenna,
determining the vertical angle between each UE from which positional information is received and the antenna based on corresponding positional information, antenna height above ground elevation level, and height above ground elevation level of each UE from which positional information is received.

19. The method according to claim 17, wherein the estimated variation in received signal strength is estimated by:
for each element of positional information, calculating the difference between a first instance of the prediction model, in which the second component models the gain of the antenna at a first vertical angle, and a second instance of the prediction model, in which the second component models the gain of the antenna at a second vertical angle, the second vertical angle being a sum of the first vertical angle and the electrical tilt change, and
estimating the variation in received signal strength as the sum of calculated differences between the first and second instances of the prediction model for each element of positional information.

20. (canceled)

21. The method according to claim 1, wherein
the positional information received from the UEs served by the antenna comprises Timing Advance, TA, information,
the TA information is used to determine distances between respective UEs from which the TA information is received and the antenna, and
the input data processed by the training model is filtered by applying at least one of:
discarding a predetermined percentage of input data received from UEs located at a distance from the antenna of more than or equal to a maximum predetermined distance,
discarding a predetermined percentage of input data received from UEs located at a distance from the antenna of less than or equal to a minimum predetermined distance,
disregarding input data received from UEs that report receiving a different reference signal from a separate antenna, or
disregarding input data received from UEs that transmit a signal strength measurement which is different to the estimated signal strength by more than or equal to an error threshold value.

22. The method according to claim 1, wherein the method further comprises:
classifying UEs into separate UE groups, wherein each separate UE group comprises:
UEs that are served by the antenna,
UEs that also receive a plurality of other reference signals from a plurality of corresponding other antennas that are not the serving antenna, and
UEs that measure a received signal strength of the same other reference signal received from the same other antenna as being the strongest measured received signal strength from among measured received signal strengths of the plurality of other reference signals, and
for each separate UE group:
generating a separate set of model coefficients, and
estimating a separate variation in received signal strength of the received reference signal corresponding to the electrical tilt change of the antenna, wherein the variation in received signal strength is estimated by: processing, in the prediction model, the separate set of model coefficient generated for the respective separate UE group, the RET increment which defines the electrical tilt change, and positional information received from the UEs in the respective separate UE group.

23. The method according to claim 1, wherein the method further comprises:
transmitting, to the plurality of UEs, the reference signal and a second reference signal from a co-azimuth antenna, wherein: the co-azimuth antenna transmits the second reference signal to a second cell at a different frequency to a frequency at which the reference signal is transmitted to a first cell;
receiving, as input data: signal strength measurements indicating received signal strength of the reference signal from UEs served in the first cell, positional information from the UEs served in the first cell signal strength measurements indicating received signal strength of the second reference signal from UEs served in the second cell, and positional information from the UEs served in the second cell;
generating model coefficients by processing the input data in the training model, wherein the model coefficients comprise an offset model coefficient corresponding to the second received reference signal;
estimating a combined variation in received signal strength of the received reference signal and the second received reference signal, the combined variation in received signal strength corresponding to an electrical tilt change of the co-azimuth antenna, wherein the combined variation in received signal strength is estimated by: processing, in the prediction model, the generated model coefficients, the RET increment which defines the electrical tilt change, positional information received from the UEs served in the first cell and positional information received from the UEs served in the second cell; and
configuring the electrical tilt of the co-azimuth antenna based on the estimated combined variation in received signal strength.

24-26. (canceled)

27. A base station configured to estimate, for an antenna of the base station, variations in received signal strength at User Equipments, UEs, the base station comprising processing circuitry and a memory containing instructions executable by the processing circuitry, whereby the base station is operable to:
transmit, to a plurality of UEs, a reference signal;
receive, as input data: signal strength measurements indicating received reference signal strength of the reference signal from UEs, and positional information from the UEs;
generate model coefficients by processing the input data in a training model; and
estimate variations in received signal strength of the received reference signal received at the UEs, the estimated variations corresponding to an electrical tilt change of the antenna, wherein the variations in received signal strength are estimated by: a prediction model configured to process: the generated model coefficients, a Remote Electrical Tilt, RET, increment which defines the electrical tilt change, and the positional information received from the UEs.

28-33. (canceled)

34. A network node configured to estimate, for an antenna of a base station, variations in received signal strength at User Equipments, UEs, the network node comprising processing circuitry and a memory containing instructions executable by the processing circuitry, whereby network node is operable to:
receive, from the base station, as input data: signal strength measurements indicating received reference signal strength of the reference signal at UEs, and positional information of the UEs;
generate model coefficients by processing the input data in a training model; and
estimate variations in received signal strength of the received reference signal received at the UEs, the estimated variations corresponding to an electrical tilt change of the antenna, wherein the variations in received signal strength are estimated by: a prediction model configured to process: the generated model coefficients, a Remote Electrical Tilt, RET, increment which defines the electrical tilt change, and the positional information received from the UEs.

35-41. (canceled)
